(19) United States
(12) Patent Application Publication
(10) Pub. No.: US 2008/0116872 A1
(43) Pub. Date: May 22, 2008

(54) DC-DC converter

(75) Inventor: Koichi Nakazono, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/976,651

(22) Filed: Oct. 26, 2007

(30) Foreign Application Priority Data
Nov. 22, 2006 (JP) 2006-315241

(51) Int. Cl. G05F 1/44; G05F 1/10

(52) U.S. Cl. 323/284; 323/282

(57) ABSTRACT

According to the present invention, there is provided a DC-DC converter converting input voltage into output voltage, including: an inductor having one terminal connected to the input voltage; a switch connected to the other terminal of the inductor and performing a switching behavior based on input of a periodic pulse signal; a monitor circuit detecting occurrence of overcurrent by converting a value of current flowing in the inductor into a monitor voltage value and comparing the monitor voltage value with a reference voltage value; a cancel out circuit fluctuating the reference voltage value so that the reference voltage value has negative correlation with fluctuation of the input voltage; and a regulator circuit fluctuating the reference voltage value so that the reference voltage value has positive correlation with fluctuation of a set value of the output voltage.

### BACKGROUND OF THE INVENTION

1. Field of the Invention

The present invention relates to a DC-DC converter, and more specifically, to a DC-DC converter having an overcurrent detection function.

2. Description of Related Art

A DC-DC converter having a function of detecting overcurrent to protect a circuit is disclosed in Japanese Unexamined Patent Application Publication No. 2003-244941. Another technology of regulating a threshold value for overcurrent protection depending on fluctuation of input voltage is disclosed in Japanese Unexamined Patent Application Publications No. 2004-343900 and No. 2002-142456. In addition, a technology of regulating a threshold value for overcurrent protection depending on output voltage is disclosed in Japanese Unexamined Patent Application Publication No. 2005-20833.

We have now discovered that the above-described related DC-DC converters have some problems explained below.

FIG. 1 shows a configuration of a DC-DC converter 100 as well known in the art. The DC-DC converter 100 comprises an inductor 101, a transistor 102, a diode 103, a capacitor 104, and a resistance element 105, and supplies output voltage to a circuit 200 connected to an output terminal 106. The transistor 102 is turned on and off according to a periodic pulse signal PS input to a gate electrode. The output voltage of the DC-DC converter 100 can be controlled by changing a Duty ratio of the pulse signal PS.

A current Im which flows in the transistor 102 of the DC-DC converter 100 is shown in FIG. 2A. When a value of the current Im becomes larger than a threshold value Th, it is determined that excessive current flows in the transistor 102. Then an operation of the DC-DC converter 100 is stopped to protect the circuit. The excessive current may be flowed from the output terminal 106 due to a failure of a circuit 200 connected to the output terminal 106, for example. In such a case, a current waveform shows a behavior as shown in a dotted line in FIG. 2A.

A value of a ripple Irip shown in FIG. 2A can be evaluated from an expression as follows;

$$I rip = \frac{V in}{L} \times T on = \frac{V in}{L} \times \frac{V out - V in}{V out} \times \frac{1}{f}$$

where Vin is the input voltage, VOUT is a set value of the output voltage, L is an inductance of the inductor 101, Ton is a time length while the transistor 102 is on, and f is a frequency of the pulse signal PS.

According to the equation above, when the input voltage or the set value of the output voltage fluctuates, the current waveform shown in a solid line in FIG. 2A changes. When the input voltage becomes smaller than it is shown in FIG. 2A, the waveform of the current Im becomes the waveform shown in a dotted line in FIG. 2B. When the input voltage becomes larger than it is shown in FIG. 2A, the waveform of the current Im becomes the waveform shown in a dotted line in FIG. 2C. When the set value of the output voltage becomes larger than it is shown in FIG. 2A, the waveform of the current Im becomes the waveform shown in a dotted line in FIG. 2D. When the set value of the output voltage becomes smaller than it is shown in FIG. 2A, the waveform of the current Im becomes the waveform shown in a dotted line in FIG. 2E.

In the related techniques, the threshold value for overcurrent detection is left constant even though the waveform of the current Im changes due to the fluctuations of the input voltage or the set value of the output voltage. Therefore, in the related techniques, it may be determined that the overcurrent occurs even though it has not occurred or it may determined that the overcurrent has not occurred even though it has actually occurred.

The input voltage becomes smaller when the input voltage supply is a battery and the battery has died, for example. On the other hand, the input voltage becomes larger when the input voltage supply is a rechargeable battery and the battery is overcharged, for example.

The set value of the output voltage fluctuates as appropriate depending on a voltage value that is needed by the circuit 200 connected to the output terminal 106.

### SUMMARY

According to one aspect of the present invention, there is provided a DC-DC converter that is capable of changing a threshold value for overcurrent detection in accordance with fluctuations of the input voltage and a set value of the output voltage.

Therefore, it is possible to detect the overcurrent properly even when an waveform of current flowing in an inductor of the DC-DC converter changes.

For example, the DC-DC converter of the present invention is the DC-DC converter converting input voltage into output voltage, including: an inductor having one terminal connected to the input voltage; a switch connected to the other terminal of the inductor and performing a switching behavior based on input of a periodic pulse signal; a monitor circuit detecting occurrence of overcurrent by comparing a monitor voltage value which is converted from a value of current flowing in the inductor with a reference voltage value; a cancel out circuit fluctuating the reference voltage value so that the reference voltage value has negative correlation with fluctuation of the input voltage; and a regulator circuit fluctuating the reference voltage value so that the reference voltage value has positive correlation with fluctuation of a set value of the output voltage.

According to another aspect of the present invention, the DC-DC converter further includes a constant voltage supply; and a resistance element having one terminal connected to the constant voltage supply. The reference voltage value is voltage of the other terminal of the resistance element. The cancel out circuit is the circuit to decrease current flowing in the resistance element when the input voltage decreases and to increase current flowing in the resistance element when the input voltage increases. The regulator circuit is the circuit to flow current with a first current value to the resistance element when the set value of the output voltage is a first voltage value and to flow current with a second current value that is smaller than the first current value to the resistance element when the set value of the output voltage is a second voltage value that is larger than the first voltage value.

As stated above, the cancel out circuit and the regulator circuit control the current flowing in the same resistance element. By having such a configuration, it is possible to change the threshold value for overcurrent detection in accordance with both the fluctuations of the input voltage and the set value of the output voltage in a simpler configuration than a configuration providing the cancel out circuit and the regulator circuit on separate bodies.

According to the present invention, it is possible to set the threshold value for overcurrent detection properly even when whichever one of the input voltage and the set value of the output voltage may fluctuate.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram to describe a DC-DC converter of a prior art;

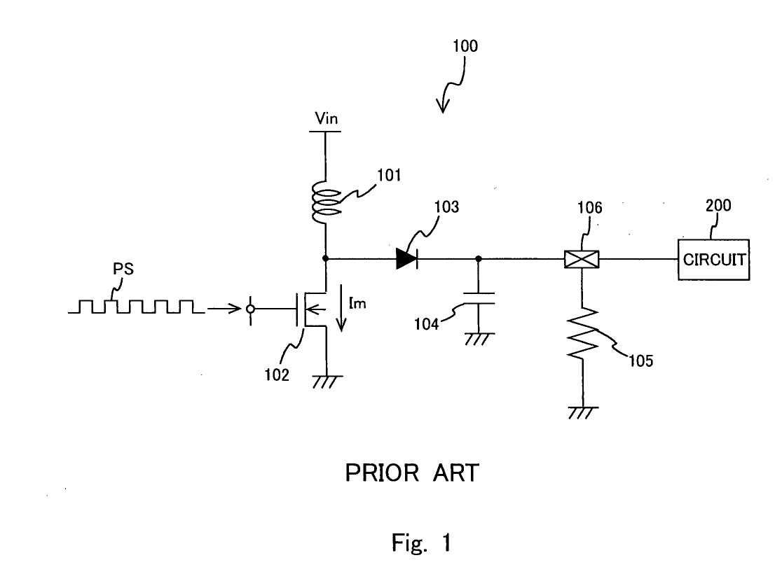

FIGS. 2A to 2E are diagrams showing a current waveform of the DC-DC converter; and

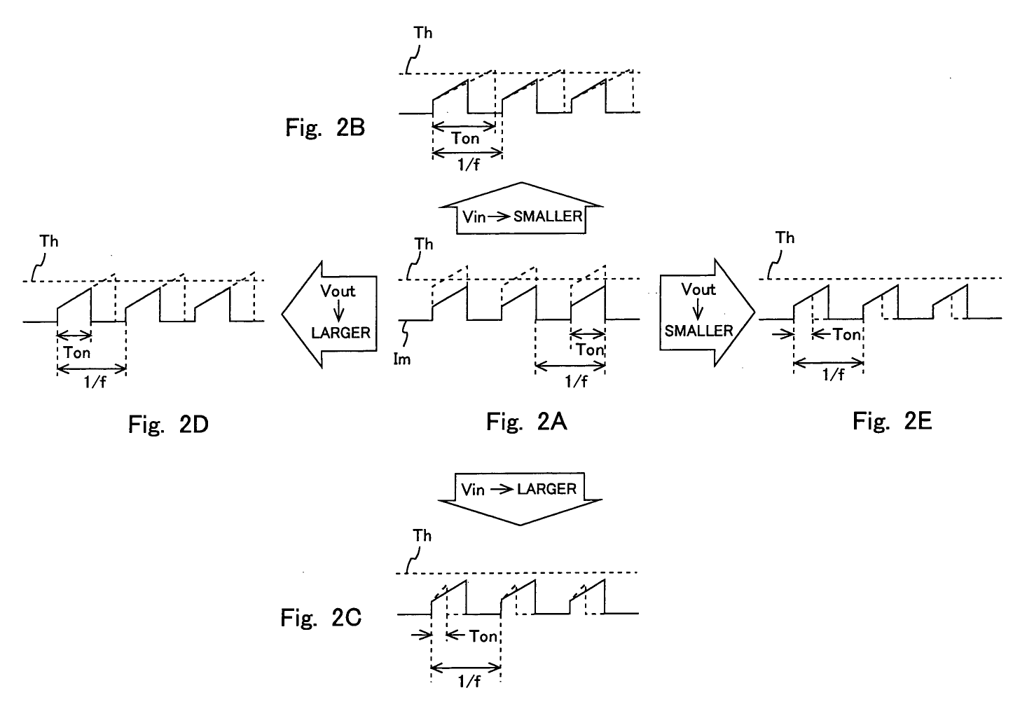

FIG. 3 is a diagram to describe a DC-DC converter of the present invention.

### DETAILED DESCRIPTION OF PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

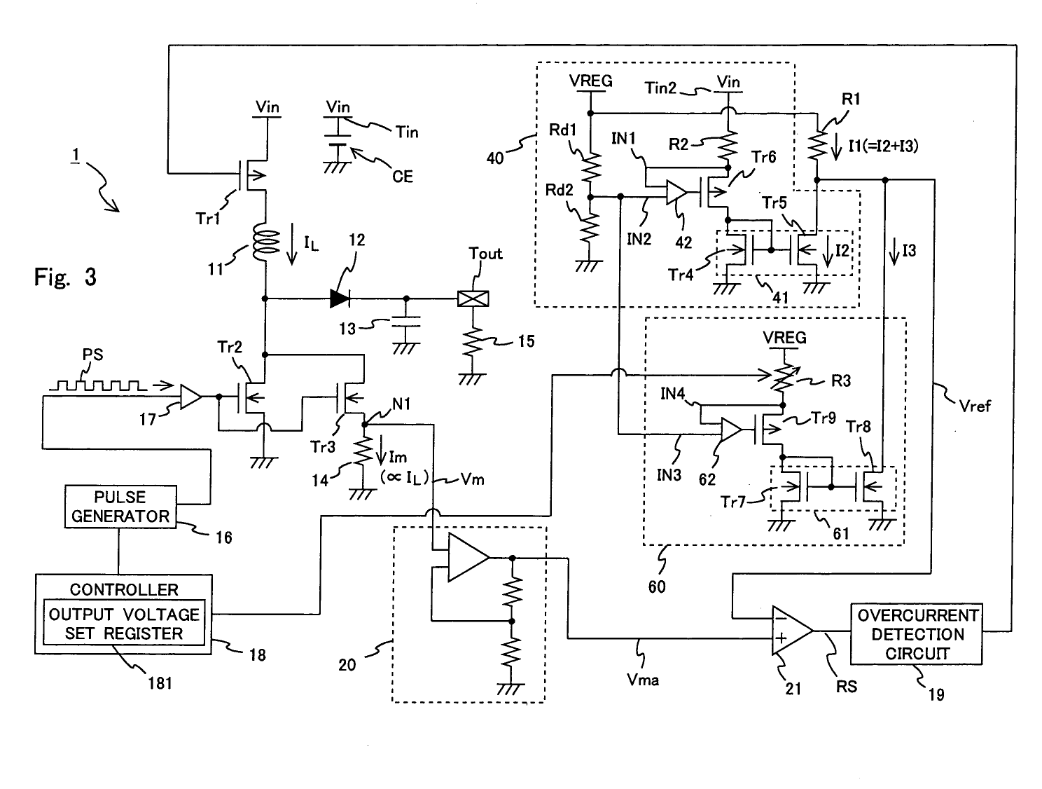

A DC-DC converter according to the present embodiment will be described below with reference to FIG. 3.

A DC-DC converter 1 comprises an input terminal Tin, an output terminal Tout, switches Tr1, Tr2, and Tr3 composed of MOS transistors, an inductor 11, a diode 12, a capacitor 13, resistance elements 14 and 15, a pulse generator 16, a buffer 17, and a controller 18.

An input voltage Vin is applied to the input terminal Tin from an input voltage supply such as a battery CE. A lithium-ion battery can be used as the battery CE, for example.

The switches Tr2 and Tr3 are turned on and off by a periodic pulse signal PS from the pulse generator 16. The switch Tr1 is turned on and off according to a signal from an overcurrent detection circuit 19 described below.

The controller 18 includes an output voltage set register 181. The controller 18 controls a Duty ratio of the pulse signal PS generated by the pulse generator 16 according to the value of output voltage set by the register. The DC-DC converter 1 converts the input voltage Vin into an output voltage Vout depending on the Duty ratio. Then the DC-DC converter 1 outputs the output voltage Vout from the output terminal Tout.

While the switch Tr3 is on, a monitor current Im flows in the resistance elements 14. The monitor current Im corresponds to a magnitude of a current IL that flows in the inductor 11. Voltage generated by an IR drop caused by the monitor current Im flowing in the resistance element 14 (monitor voltage value Vm) appears in one end of the resistance element 14 (node N1). In the present invention, we assume that the monitor current Im is the current that flows in the resistance element 14. However, it is not limited to this embodiment. For example, the monitor current Im may be the current that flows in the diode 12 or may be the current that flows in the switch Tr2. All that is required here is that the monitor current Im either directly or indirectly reflects the current that flows in the inductor 11. In other words, all that is required here is that the monitor voltage value Vm is generated by converting the value of the current flowing in the inductor 11 into the voltage value.

The monitor voltage value Vm is amplified by an amplifier 20. Then the amplified monitor voltage value Vm is input to the comparator 21. It is not absolutely necessary that the monitor voltage value Vm is amplified using the amplifier 20. However, when the monitor voltage value Vm is amplified using the amplifier 20, it is possible to make a comparison in a comparator 21 with a high degree of accuracy. The comparator 21 compares the amplified monitor voltage value Vma with a reference voltage value Vref. Then the comparator 21 outputs the comparison result RS to the overcurrent detection circuit 19.

When the comparison result RS shows that the amplified monitor voltage value Vma is larger than the reference voltage value Vref, the overcurrent detection circuit 19 turns off the switch Tr1 and stops the operation of the DC-DC converter 1 to prevent the DC-DC converter 1 from being broken down due to the overcurrent.

Now, a description will be made on how the reference voltage value Vref occurs and how to regulate the reference voltage value Vref in accordance with the fluctuations of the input voltage Vin and the set value of the output voltage Vout.

A resistance element R1 has one end connected to the constant voltage supply VREG. The other end of the resistance element R1 (node N2) has the reference voltage value Vref. The reference voltage value Vref is therefore expressed by the expression

Vref=Vreg−I1*r1,

where Vreg is, the voltage value of the constant voltage supply VREG, I1 is the current value that flows in the resistance element R1, and r1 is the resistance value of the resistance element R1. Therefore, it is possible to regulate the reference voltage value Vref by changing the current value I1 that flows in the resistance element R1.

The current value I1 can be regulated by a cancel out circuit 40 and a regulator circuit 60.

The cancel out circuit 40 includes a current mirror 41 composed of a pair of transistors Tr4 and Tr5, a transistor Tr6, an operational amplifier 42, resistance elements Rd1 (resistance value rd1) and Rd2 (resistance value rd2), R2 (resistance value r2), the constant voltage supply VREG, an input voltage terminal Tin2 to which the input voltage Vin is supplied. One transistor Tr5 which composes the current mirror 41 is connected to the resistance element R1. The current value I1 can be controlled by controlling the current I2 that flows in the transistor Tr5.

Voltage of one input IN1 of the operational amplifier 42 is the voltage of a contact point of the resistance element Rd1 and the resistance element Rd2 (node N3). The voltage of the node N3 is expressed by Vreg*rd2/(rd1+rd2). Voltage of the other input IN2 of the operational amplifier 42 is the voltage smaller than the input voltage Vin by the IR drop caused by the resistance element R2. The output of the operational amplifier 42 is connected to a gate electrode of the transistor Tr6.

When the input voltage Vin becomes smaller in the cancel out circuit 40, the current that flows in the current mirror circuit 41 becomes smaller, which makes the current I2 that flows in the transistor Tr5 smaller. When the current I2 becomes smaller, the current I1 that flows in the resistance element R1 becomes smaller, which makes the reference voltage value Vref larger. In summary, when the input voltage Vin becomes smaller, the reference voltage value Vref becomes larger. On the contrary, when the input voltage Vin becomes larger, the current I1 that flows in the resistance element R1 becomes larger, which makes the reference voltage value Vref smaller.

As stated above, the cancel out circuit 40 fluctuates the reference voltage value Vref so that the reference voltage value has negative correlation with the fluctuation of the input voltage Vin.

The regulator circuit 60 includes a current mirror 61 composed of transistors Tr7 and Tr8, a variable resistance element R3 (variable resistance value r3), an operational amplifier 62, a transistor Tr9, and the constant voltage supply VREG. One transistor Tr8 of the current mirror 61 is connected to the resistance element R1. The current value I1 can be controlled by controlling a current I3 that flows in the transistor Tr8.

Voltage of one input IN3 of the operational amplifier 62 is the voltage of the node N3 described above. Voltage of the other input IN4 of the operational amplifier 62 is the voltage smaller than the voltage Vreg of the constant voltage supply VREG by an amount of the IR drop caused by the variable resistance element R3. The output of the operational amplifier 62 is input to the gate electrode of the transistor Tr9.

The resistance value r3 of the variable transistor element R3 is controlled by the controller 18. The controller 18 controls the resistance value of the variable resistance element R3 depending on the value of the output voltage Vout set in the output voltage set resistor 181.

When the controller 18 controls the resistance value r3 of the variable resistance element R3 to decrease, the current that flows in the current mirror 61 becomes larger, which the current I3 that flows in the transistor Tr8 becomes larger. When the current I3 becomes larger, the current I1 that flows in the resistance element R1 becomes larger, which the reference voltage value Vref becomes smaller. On the contrary, when the controller 18 controls the resistance value r3 of the variable resistance element R3 to increase, the reference voltage value Vref becomes larger. As stated above, the reference voltage value Vref can be controlled by controlling the resistance value r3 of the variable resistance element R3.

When the set value of the output voltage Vout set by the output voltage set resistor 181 increases, the controller 18 increases the resistance value r3 of the variable resistance element R3, for example. As a result, the regulator circuit 60 decreases the current I1 that flows in the resistance element R1, which increases the reference voltage value Vref.

On the contrary, when the set value of the output voltage Vout set by the output voltage set resistor 181 decreases, the controller 18 decreases the resistance value r3 of the variable resistance element R3. As a result, the regulator circuit 60 increases the current I1 that flows in the resistance element R1, which decreases the reference voltage value Vref.

As stated above, the regulator circuit 60 fluctuates the reference voltage value Vref so that the reference voltage value has positive correlation with the fluctuation of the set value of the output voltage Vout.

A behavior of the reference voltage value Vref against the input voltage Vin and the set value of the output voltage Vout can be expressed by the following equation.

$$V ref = V reg - \frac{V in - K \times V reg}{r 2} \times r 1 \frac{V reg - K \times V reg}{r 3} \times r 1$$

A second term of the above equation is a contribution made by the cancel out circuit 40 and a third term of the above equation is a contribution made by the regulator circuit 60. Note that K=rd2/(rd1+rd2).

Note that the DC-DC 1 converter includes at least one of the cancel out circuit 40 and regulator circuit 60.

Note that a process variation of the voltage Vreg of the constant voltage supply VREG can be made small by trimming a fuse after being produced, for example. The process variation of the resistance values of the resistance elements R1, R2, R3, Rd1, and Rd2 cancels with each other. Therefore, it is possible to decrease the variation that appears in the reference voltage value Vref, which to generate the reference voltage value Vref that has high accuracy.

It is apparent that the present invention is not limited to the above embodiment, but may be modified and changed without departing from the scope and spirit of the invention.

What is claimed is:

1. A DC-DC converter converting input voltage into output voltage, comprising:
an inductor having one terminal connected to the input voltage;
a switch connected to the other terminal of the inductor and performing a switching behavior based on input of a periodic pulse signal;
a monitor circuit detecting occurrence of overcurrent by converting a value of current flowing in the inductor into a monitor voltage value and comparing the monitor voltage value with a reference voltage value;
a cancel out circuit fluctuating the reference voltage value so that the reference voltage value has negative correlation with fluctuation of the input voltage; and
a regulator circuit fluctuating the reference voltage value so that the reference voltage value has positive correlation with fluctuation of a set value of the output voltage.

2. A DC-DC converter according to claim 1, comprising:
a constant voltage supply; and
a resistance element having one terminal connected to the constant voltage supply,
wherein the reference voltage value is the voltage value of the other terminal of the resistance element.

3. The DC-DC converter according to claim 2, wherein:
the cancel out circuit is the circuit to decrease current flowing in the resistance element when the input voltage decreases or to increase current flowing in the resistance element when the input voltage increases; and
the regulator circuit is the circuit to flow current with a first current value to the resistance element when the set value of the output voltage is a first voltage value or to flow current with a second current value that is smaller than the first current value to the resistance element when the set value of the output voltage is a second voltage value that is larger than the first voltage value.

4. The DC-DC converter according to claim 3, wherein the cancel out circuit comprises:
a first transistor having one of a source and a drain electrically connected to the other terminal of the resistance element; and
a second transistor configuring a current mirror circuit by pairing with the first transistor, and
wherein current flowing between the source and the drain of the second transistor decreases when the input voltage decreases or the current flowing between the source and the drain of the second transistor increases when the input voltage increases.

5. A DC-DC converter comprising a switching element that performs a switching operation to convert an input voltage into an output voltage having a predetermined level, a monitor circuit that obtains a monitor voltage from a current relative to a current flowing through the switching element and compares the monitor voltage with a reference voltage to produce a control signal when the monitor voltage reaches the reference voltage, and a control circuit that varies the reference voltage in at least one of first and second matters, the first matter being such that the reference voltage is varied in a reverse direction to variation of the input voltage, and the second matter being such that the reference voltage is varied in a same direction as variation of the predetermined level of the output voltage.

6. The converter as claimed in claim 5, wherein the reference voltage is varied in both first and second matters.

7. The converter as claimed in claim 5, wherein the control circuit includes a register which temporarily stores information indicative of the predetermined level of the output voltage, the predetermined level being thereby variable in accordance with the information.

8. The converter as claimed in claim 5, wherein the control circuit includes an output node from which the reference voltage is derived, a voltage node supplied with a substantially constant voltage, and a resistor connected between the output node and the voltage node, the control circuit further including a cancel out circuit that has a current source connected to the output node and supplies the resistor with a current variable in accordance with the input voltage.

9. The converter as claimed in claim 5, wherein the control circuit includes an output node from which the reference voltage is derived, a voltage node supplied with a substantially constant voltage, and a resistor connected between the output node and the voltage node, the control circuit further including a regulator circuit that has a current source connected to the output node and supplies the resistor with a current variable in accordance with the predetermined level of the output voltage.

10. The converter as claimed in claim 5, wherein the control circuit includes an output node from which the reference voltage is derived, a voltage node supplied with a substantially constant voltage, and a resistor connected between the output node and the voltage node, the control circuit further including a cancel out circuit that has a first current source connected to the output node and supplies the resistor with a first current variable in accordance with the input voltage and a regulator circuit that has a second current source connected to the output node and supplies the resistor with a second current variable in accordance with the predetermined level of the output voltage.
